(19) United States
(12) Patent Application Publication
(10) Pub. No.: US 2026/0272217 A1
(43) Pub. Date: Sep. 17, 2026

(54) ROAST FORK ASSEMBLY AND BARBECUE APPARATUS

(71) Applicant: Dongguan Haohong Outdoor Products Technology Co., Ltd., Dongguan (CN)

(72) Inventor: Min WANG, Dongguan (CN)

(73) Assignee: Dongguan Haohong Outdoor Products Technology Co., Ltd., Dongguan (CN)

(21) Appl. No.: 19/551,205

(22) Filed: Feb. 26, 2026

(30) Foreign Application Priority Data
Mar. 12, 2025 (CN) 202520436118.2

(51) Int. Cl. A47J 37/04; A47J 37/07

(52) U.S. Cl. CPC A47J 37/041; A47J 37/0786

(57) ABSTRACT

A roast fork assembly includes a pivot portion and a roast fork portion. The pivot portion is movably connected to the roast fork portion, and the roast fork portion is capable of swinging and being fixed relative to the pivot portion. The roast fork portion includes two roast forks and a rotation rod, and each roast fork is sleeved at the rotation rod and provided opposite to each other.

### CROSS-REFERENCE TO RELATED APPLICATIONS

This application claims priority to Chinese Patent Application No. 202520436118.2, filed on March 12, 2025, the entire contents of which are incorporated herein by reference.

### TECHNICAL FIELD

The present application relates to the technical field of barbecue apparatus, and particularly to a roast fork assembly and a barbecue apparatus.

### BACKGROUND

In existing barbecue apparatus technology, when roasting large pieces of food such as whole chickens, ducks, and lamb legs, a roast fork is typically used to fix the food to a rotation rod, which is driven by a rotary motor to achieve uniform heating.

However, existing barbecue apparatus technology has some limitations. First, the position adjustment of the roast fork is usually relatively fixed, making it difficult to flexibly adjust the angle and position according to the size and shape of the food. Second, within the limited space of the barbecue apparatus, the movement and adjustment of the roast fork is not convenient, which may lead to inconvenience when placing and removing food, and may even prevent the full utilization of the internal space of the barbecue apparatus due to space constraints, thereby reducing roasting efficiency.

### SUMMARY

The main purpose of the present application is to provide a roast fork assembly and a barbecue apparatus, aiming to solve the technical problem that the inconvenience of moving and adjusting the roast fork in related technologies reduces roasting efficiency.

To achieve the above purpose, the present application provides a roast fork assembly including:

a pivot portion; and

a roast fork portion, the pivot portion is movably connected to the roast fork portion, and the roast fork portion is capable of swinging and being fixed relative to the pivot portion.

In an embodiment, the roast fork portion includes two roast forks and a rotation rod, and each roast fork is sleeved at the rotation rod and provided opposite to each other.

In an embodiment, each roast fork includes a fork head and a connection portion, each connection portion is sleeved at the rotation rod, each connection portion is provided with an annular groove along a circumference of the connection portion, and a tail of the fork head is confined within the annular groove.

In an embodiment, the roast fork assembly includes a fastener, and the connection portion is provided with a screw hole for the fastener to connect.

In an embodiment, an end of the fastener distant from the screw hole is circular; and/or

an end of the fastener distant from the screw hole is triangular.

The present application also proposes a barbecue apparatus, including:

an apparatus body;

the roast fork assembly as described above, and the pivot portion of the roast fork assembly is rotatably passed through the apparatus body.

In an embodiment, the barbecue apparatus includes a support body being movably provided at the apparatus body, one end of the support body is provided with a limit groove, and the roast fork assembly is confined within the limit groove.

In an embodiment, the support body includes a support rod and a base, the support rod is erected at the base, the base is provided at the apparatus body, an end of the support rod distant from the base is provided with the limit groove, and an end of the roast fork assembly distant from the pivot portion is confined within the limit groove.

In an embodiment, the barbecue apparatus includes at least one slide body, one slide body is connected to one end of the roast fork assembly, another slide body is connected to the pivot portion, and each slide body is movably connected to a side wall of the apparatus body.

In an embodiment, the apparatus body is provided with two side walls opposing to each other, each side wall is provided with a limit guide rail, and each slide body is movably connected to one of the limit guide rails.

The technical solution of the present application, by setting a pivot portion at one end of the roast fork assembly, allows for more flexible adjustment of the fork assembly's position. The pivot portion can rotate 360 degrees relative to the roast fork portion, that is, the roasted food on the roast fork portion can be adjusted according to the direction of the pivot portion. Compared to the prior art where the roast fork assembly is typically fixed to both ends of other cooperating apparatus, the present application allows the roast fork assembly to be adjusted at different angles and directions, thereby better adapting to ingredients of different shapes and sizes, improving the flexibility and uniformity of roasting, and achieving the movement and adjustment of the roast fork in a limited space, enhancing operational flexibility.

### BRIEF DESCRIPTION OF THE DRAWINGS

In order to explain the embodiments of the present application or the technical solutions in the existing technology more clearly, the accompanying drawings needed to be used in the description of the embodiments or the existing technology will be briefly introduced below. Obviously, the accompanying drawings in the following description are only some embodiments of the present application, other accompanying drawings can be obtained based on the provided accompanying drawings without exerting creative efforts for those skilled in the art.

FIG. 1 is a structural schematic view of a barbecue apparatus provided by an embodiment of the present application.

FIG. 2 is a structural schematic view of a barbecue apparatus provided by another embodiment of the present application.

FIG. 3 is a structural schematic view of an embodiment in which a roast fork assembly and a support body cooperate in FIG. 1.

FIG. 4 is a structural schematic view of an embodiment in which a roast fork assembly and a slide body cooperate in FIG. 2.

The realization of the purpose, functional features and advantages of the present application will be further described in conjunction with the embodiments and with reference to the accompanying drawings.

### DETAILED DESCRIPTION OF THE EMBODIMENTS

The technical solutions in the embodiments according to the present application will be clearly and completely described below in conjunction with the accompanying drawings in the embodiments according to the present application, and it is clear that the described embodiments are only a part of the embodiments according to the present application, and not all of the embodiments. Based on the embodiments in the present application, all other embodiments obtained by those skilled in the art without making creative labor fall within the scope of the present application.

It should be noted that if there are directional instructions (such as up, down, left, right, front, back or the like) involved in the embodiments of the present application, the directional indications are only used to explain the relative positional relationship, movement and so on between various components in a specific posture (as shown in the accompanying drawings). If the specific posture changes, the directional indication will also change accordingly.

Furthermore, if the embodiments of the present application involve descriptions such as “first,” “second,” etc., these descriptions are only for descriptive purposes and should not be construed as indicating or implying their relative importance or implicitly specifying the number of technical features indicated. Therefore, features defined with “first” or “second” may explicitly or implicitly include at least one of those features. Furthermore, the use of “and/or” or “and/or” throughout the text implies three parallel solutions. For example, “A and/or B” includes solution A, solution B, or a solution satisfying both A and B simultaneously. In addition, the technical solutions of various embodiments can be combined with each other, but it is based on that those skilled in the art can realize. When the combination of technical solutions is contradictory or cannot be realized, it should be considered that such combination of technical solutions does not exist and is not within the scope claimed by the present application.

The present application proposes a roast fork assembly 100.

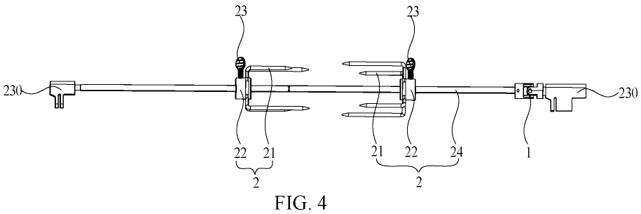

Referring to FIG. 3 to FIG. 4, in an embodiment of the present application, the roast fork assembly 100 includes a pivot portion 1 and a roast fork portion 2. The pivot portion 1 is movably connected to the roast fork portion 2, and the roast fork portion 2 is capable of swinging and being fixed relative to the pivot portion 1.

In this embodiment, the roast fork assembly 100 is used to fix and support the food, the pivot portion 1 is used to adjust the roast fork assembly 100 at different angles and directions, and the roast fork portion 2 is the end of the roast fork assembly 100 distant from the pivot portion 1, used to fix the food. The type of barbecue apparatus 200 includes, but is not limited to, ovens, grills, etc. It is understood that the roast fork portion 2 can swing and be fixed relative to the pivot portion 1, thereby allowing the roast fork assembly 100 to swing in a non-coaxial manner when used with other apparatus, that is, the roast fork assembly 100 can rotate 360 degrees relative to other apparatus, not limited to left and right rotation, but also up and down rotation. In some embodiments, the pivot portion 1 can be configured in the form of, but is not limited to, a universal coupling or a ball joint. That is, a universal coupling or a ball joint can be provided between the roast fork assembly 100 and the apparatus body 210 (or other mating apparatus). Alternatively, the roast fork assembly 100 can be connected to the apparatus body 210 (or other mating apparatus) via a rotatable connection, or the roast fork assembly 100 can be connected to the apparatus body 210 (or other mating apparatus) via a hinge connection. This is not limited, as long as the roast fork assembly 100 can rotate 360 degrees relative to the apparatus body 210 (or other mating apparatus). In some embodiments, one end of the pivot portion 1 can be connected to the roast fork portion 2 by a snap-fit, plug-in, or other method, and this is not limited.

The technical solution of the present application, by setting a pivot portion 1 at one end of the roast fork assembly 100, allows for more flexible adjustment of the fork assembly's 100 position. The pivot portion can rotate 360 degrees relative to the roast fork portion 2, that is, the roasted food on the roast fork portion can be adjusted according to the direction of the pivot portion. Compared to the prior art where the roast fork assembly 100 is typically fixed to both ends of other cooperating apparatus, the present application allows the roast fork assembly 100 to be adjusted at different angles and directions, thereby better adapting to ingredients of different shapes and sizes, improving the flexibility and uniformity of roasting, and achieving the movement and adjustment of the roast fork in a limited space, enhancing operational flexibility.

In an embodiment of the present application, the roast fork portion 2 includes two roast forks and a rotation rod 24, and each roast fork is sleeved at the rotation rod 24 and provided opposite to each other. One end of the rotation rod 24 is connected to an adjustment assembly.

In this embodiment, to improve the efficient roasting capability of the roast fork assembly 100, the two roast forks are arranged opposite to each other. By fitting the roast forks onto the rotation rod 24, the rotation of the rotation rod 24 ensures that the food is heated evenly during roasting. The rotation rod 24 can be driven by a motor or manually. The above-mentioned configuration allows the position and angle of the roast fork assembly 100 to be flexibly adjusted according to the shape and size of the food, adapting to different roasting needs.

In an embodiment of the present application, each roast fork includes a fork head 21 and a connection portion 22, each connection portion 22 is sleeved at the rotation rod 24, each connection portion 22 is provided with an annular groove along a circumference of the connection portion, and a tail of the fork head 21 is confined within the annular groove.

In this embodiment, it should be noted that the shape and size of the annular groove match the tail of the fork head 21. The connection portion 22 is sleeved onto the rotation rod 24 and secured to the rotation rod 24 by threads or snap-fit. The above-mentioned configuration ensures that the roast fork will not loosen or fall off during rotation, providing stable support, and preventing the food from being affected by the fork's movement during roasting and affecting the roasting results.

In an embodiment of the present application, the roast fork assembly 100 includes a fastener 23, and the connecting portion 22 is provided with a screw hole for the fastener 23 to connect.

In this embodiment, the roast fork can be securely fixed to the connection portion 22 by engaging the fastener 23 (such as a screw or bolt) with the screw hole of the connection portion 22. Meanwhile, the screw hole design allows the fastener 23 to be quickly screwed in or out, facilitating rapid replacement of the roast fork or cleaning.

In an embodiment of the present application, an end of the fastener 23 distant from the screw hole is circular; and/or an end of the fastener 23 distant from the screw hole is triangular.

In this embodiment, to facilitate manual adjustment by the user, the end of the fastener 23 distant from the screw hole is circularly shaped to provide a larger contact area, making it easier for the user to apply force when tightening or loosening the fastener 23.

To improve the comfort of manual operation, the end of the fastener 23 distant from the screw hole is triangularly shaped, providing multiple contact points, allowing the user to grip the fastener 23 more stably during operation. This design not only facilitates manual operation but also improves operational comfort.

The present application also proposes a barbecue apparatus 200 including an apparatus body 210 and the aforementioned roast fork assembly 100. The specific structure of the roast fork assembly 100 is as described in the above embodiment. Since this barbecue apparatus 200 adopts all the technical solutions of all the above embodiments, it possesses at least all the beneficial effects brought about by the technical solutions of the above embodiments, which will not be elaborated further here. The pivot portion 1 of the roast fork assembly 100 is rotatably passed through the apparatus body 210.

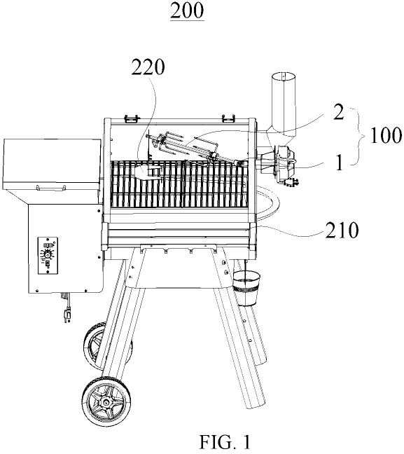

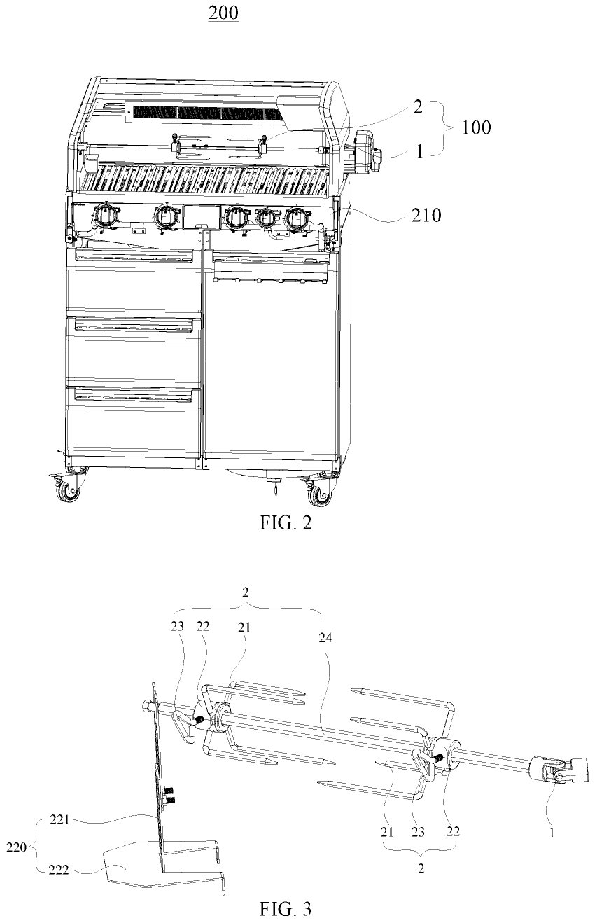

Referring to FIG. 1 to FIG. 2, in this embodiment, the barbecue apparatus 200 is used in scenarios such as family gatherings, outdoor camping, restaurants, and commercial barbecues. The apparatus body 210 provides stable support and working space for the entire barbecue apparatus 200. The apparatus body 210 has a cover (not shown here for illustration of the internal structure). It should be noted that the bottom of the apparatus body 210 can be configured in two ways. For ease of outdoor use, the bottom of the apparatus body 210 is equipped with casters to improve the mobility of the entire barbecue apparatus 200; the bottom of the apparatus body 210 can also be immovable box legs. In some embodiment, the barbecue apparatus 200 is in the form of an oven. The above-mentioned configuration, by rotation and multi-directional adjustment design, allows the oven to achieve uniform heating of food and adapt to the baking needs of various foods. The other end of the pivot portion 1 passes through the apparatus body 210 and is connected to the drive unit. The drive unit's operation includes, but is not limited to, manual or motor-driven methods; no specific method is specified here. It can also be equipped with both a manual adjustment device and a motor-driven device. When a quick adjustment of the roast fork position is needed, the user can manually operate the handle or knob; when long-term, even grilling is required, the mode can be switched to electric mode, allowing the motor to automatically control the rotation and angle changes of the roast fork, thus facilitating user operation. It should be noted that, in addition to electric adjustment, to make the barbecue apparatus 200 more intelligent, it can also include sensors and an intelligent control module. The sensors and intelligent control module are electrically connected to the pivot portion 1 to provide a more personalized and precise grilling experience; this will not be elaborated upon here. The above-mentioned configuration improves the flexibility and uniformity of roasting, enabling the movement and adjustment of the roast fork within a limited space, thus enhancing operational flexibility. Meanwhile, the quick installation and disassembly design, stable fixation, and compact spatial layout further improve the oven's ease of operation, stability, and durability.

In an embodiment of the present application, the barbecue apparatus 200 also includes a support body 220 being movably provided at the apparatus body 210, one end of the support body 220 is provided with a limit groove, and the roast fork assembly 100 is confined within the limit groove.

In this embodiment, it should be noted that, to further improve the flexibility of adjustment, one end of the roast fork assembly 100 is fixed to the apparatus body 210, and the other end of the roast fork assembly 100 is supported by a movable support body 220. The support body 220 and the apparatus body 210 together support the entire roast fork assembly 100. Below the roast fork assembly 100, there is also a component for connecting the support body 220 to the apparatus body 210. This component includes, but is not limited to, a roasting rack. The support body 220 can be connected to this component via a slide rail and slider, a snap-fit groove and snap-fit block, etc., and this component is located on the apparatus body 210. The support body 220 and the pivot portion 1 are located in opposite directions to the roast fork assembly 100. It is understood that the support body 220 can be telescopic, rotatable, or fixed. The limit groove is used to limit excessive movement of the roast fork assembly 100, while allowing it to rotate or swing within a certain range. The shape and size of the limit groove match the roast fork assembly 100, and its shape includes, but is not limited to, arcs, semicircles, etc., which are not specified here. The above-mentioned configuration uses the limit groove of the support body 220 to fix the position of the roast fork assembly 100, preventing it from shaking due to external force or vibration during roasting. Simultaneously, because the support body 220 is movably provided at the apparatus body 210, the position adjustment of the roast fork assembly 100 is more flexible.

In an embodiment of the present application, the support body 220 includes a support rod 221 and a base 222, the support rod 221 is erected at the base 222, the base 222 is provided at the apparatus body 210, an end of the support rod 221 distant from the base 222 is provided with the limit groove, and an end of the roast fork assembly 100 distant from the pivot portion 1 is confined within the limit groove.

In this embodiment, it should be noted that the height and position of the support rod 221 can be adjusted according to actual needs. Adjustments can be made using threads, gears, etc., to change the position and angle of the roast fork assembly 100. The support rod 221 can be connected to the base 222 by integral molding, welding, screwing, or other methods. In an embodiment, the end of the base 222 distant from the support rod 221 is bent to form a bending block. A grill rack is provided on the side of the apparatus body 210 facing the base 222. The base 222 is engaged with the grill rack via the bending block, thus connecting the base 222 to the apparatus body 210. To further facilitate airflow within the barbecue apparatus 200, multiple through holes are spaced apart inside the support body 220. By the design of the support rod 221 and the limit groove, the user can quickly install the roast fork assembly 100 and adjust the angle of the roast fork and the position of the roast fork as needed.

In an embodiment of the present application, the adjustment component further includes at least one slide body 230, one slide body 230 is connected to one end of the roast fork assembly 100, another slide body 230 is connected to the pivot portion 1, and each slide body 230 is movably connected to a side wall of the apparatus body 210.

In this embodiment, to facilitate multi-directional adjustment of the roast fork assembly 100, the slide body 230 is used to adjust the position of the roast fork assembly 100 within the barbecue apparatus 200. It should be noted that the number of slide bodies 230 may be one or two, but two are preferred here to facilitate synchronous movement of the roast fork assembly 100 within the apparatus body 210. Two sliding bodies 230 are respectively disposed at both ends of the roast fork assembly 100, one slide body 230 is connected to the pivot portion 1, and the connection method here includes, but is not limited to, using connectors (such as flanges or snap-fits), and the other slide body 230 is connected to one end of the roast fork assembly 100, and the connection method here includes, but is not limited to, using connectors (such as flanges or snap-fits). The above-mentioned configuration allows for quick adjustment of the position and angle of the roast fork assembly 100 by simple sliding operations, improving the user experience.

In an embodiment of the present application, the apparatus body 210 is provided with two side walls opposing to each other, each side wall is provided with a limit guide rail, and each slide body 230 is movably connected to one of the limit guide rails.

In this embodiment, it should be noted that the limit guide rail provides a clear boundary for the movement of the slide body 230, preventing the slide body 230 from deviating from a predetermined trajectory during movement. The limit guide rails are preferably linear and are respectively installed on the two side walls. The above-mentioned configuration allows the roast fork assembly 100 to move back and forth along the two side walls of the apparatus body 210, enabling the positions of the roast fork assembly 100 and the pivot portion 1 to be flexibly adjusted according to the shape of the food and roasting requirements. Furthermore, the presence of the pivot portion 1 allows the roast fork assembly 100 to rotate 360 degrees, increasing the roast fork assembly 100’s versatility in various applications.

The above description is merely some exemplary embodiments of the present application and does not limit the scope of the present application. Any equivalent structural transformations made based on the technical concept of the present application and the description and drawings, or direct/indirect applications in other related technical fields, are included within the scope of the present application.

What is claimed is:

1. A roast fork assembly, comprising:
a pivot portion; and
a roast fork portion, wherein the pivot portion is movably connected to the roast fork portion, and the roast fork portion is capable of swinging and being fixed relative to the pivot portion.

2. The roast fork assembly according to claim 1, wherein the roast fork portion comprises two roast forks and a rotation rod, and each roast fork is sleeved at the rotation rod and provided opposite to each other.

3. The roast fork assembly according to claim 2, wherein each roast fork comprises a fork head and a connection portion, each connection portion is sleeved at the rotation rod, each connection portion is provided with an annular groove along a circumference of the connection portion, and a tail of the fork head is confined within the annular groove.

4. The roast fork assembly according to claim 1, wherein the roast fork assembly comprises a fastener, and the connection portion is provided with a screw hole for the fastener to connect.

5. The roast fork assembly according to claim 4, wherein an end of the fastener distant from the screw hole is circular; and/or
an end of the fastener distant from the screw hole is triangular.

6. A barbecue apparatus, comprising:
an apparatus body; and
the roast fork assembly according to claim 1, wherein the pivot portion of the roast fork assembly is rotatably passed through the apparatus body.

7. The barbecue apparatus according to claim 6, further comprising a support body movably provided at the apparatus body, wherein one end of the support body is provided with a limit groove, and the roast fork assembly is confined within the limit groove.

8. The barbecue apparatus according to claim 7, wherein the support body comprises a support rod and a base, the support rod is erected at the base, the base is provided at the apparatus body, an end of the support rod distant from the base is provided with the limit groove, and an end of the roast fork assembly distant from the pivot portion is confined within the limit groove.

9. The barbecue apparatus according to claim 6, further comprising at least two slide bodies, wherein one slide body is connected to one end of the roast fork assembly, another slide body is connected to the pivot portion, and each slide body is movably connected to a side wall of the apparatus body.

10. The barbecue apparatus according to claim 9, wherein the apparatus body is provided with two side walls opposing to each other, each side wall is provided with a limit guide rail, and each slide body is movably connected to one of the limit guide rails.
